(19) United States
(12) Patent Application Publication
(10) Pub. No.: US 2025/0378118 A1
(43) Pub. Date: Dec. 11, 2025

(54) GENERATING WEB CRAWLING DISCOVERY ACTIONS USING GENERATIVE ARTIFICIAL INTELLIGENCE (AI) MODELS

(71) Applicant: Microsoft Technology Licensing, LLC, Redmond, WA (US)

(72) Inventors: Siarhei ALONICHAU, Seattle, WA (US); Sydney Beth MACDONALD, Seattle, WA (US)

(73) Assignee: Microsoft Technology Licensing, LLC, Redmond, WA (US)

(21) Appl. No.: 18/737,582

(22) Filed: Jun. 7, 2024

(51) Int. Cl. G06F 16/951

(52) U.S. Cl. CPC G06F 16/951; G06N 3/0475; G06N 5/045

(57) ABSTRACT

This disclosure describes a framework for generating improved uniform resource locator (URL) discovery actions for classes of URLs using a discovery action system. Specifically, this disclosure describes a discovery action system that utilizes a prompt generation process with a generative artificial intelligence (AI) model to efficiently generate optimal URL discovery actions for different URL classes. For instance, the discovery action system utilizes an iterative prompt generation process that incorporates previously generated discovery actions with a generative AI model to determine improved discovery actions for a specific URL class. These improved discovery actions are then used to determine new URLs for the class. In addition, once the optimal URL discovery actions are determined for a URL class, the discovery action system facilitates the discovery of new URLs for the URL class without relying on the generative AI model.

### BACKGROUND

In recent years, significant advancements have been made in both hardware and software domains, particularly in the area of web discovery and search engine indexing. Web discovery aims to identify new and useful uniform resource locators (URLs) for search engine indexes. Most existing web discovery systems analyze outgoing URL links during an index recrawl cycle, with an emphasis on seed URLs to reveal additional new outgoing URL links with each visit. For example, upon recrawling a seed URL, many existing web discovery systems generate several new and useful outgoing URL links. However, this traditional approach has many technical shortcomings. For instance, the process of analyzing out-links during the recrawl cycle can be resource-intensive, time-consuming, and unreliable, which can lead to delays in discovering new URLs.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of the discovery action system that utilizes prompt generation processes and generative artificial intelligence (AI) models to discover new uniform resource locators (URLs).

FIG. 2 illustrates an example computing environment in which the discovery action system is implemented.

FIG. 3 illustrates an example flow diagram of the discovery action system performing discovery action optimization and discovery class execution.

FIGS. 4A-4B illustrate example sequence diagrams for the discovery action system performing discovery action optimization to determine discovery actions using the generative AI model.

FIG. 5 illustrates an example table of URL discovery actions previously generated for a URL class.

FIG. 6 illustrates an example sequence diagram of a discovery class execution process for discovering new URLs using proven or optimized discovery actions.

FIG. 7 illustrates an example series of acts of a computer-implemented method for using one or more generative artificial intelligence (AI) models to generate visualizations and insights from large datasets.

FIG. 8 illustrates example components included within a computer system used to implement the discovery action system.

### DETAILED DESCRIPTION

This disclosure describes a framework for generating improved uniform resource locator (URL) discovery actions for classes of URLs using a discovery action system. Specifically, this disclosure describes a discovery action system that utilizes a prompt generation process with a generative artificial intelligence (AI) model to efficiently generate optimal URL discovery actions for different classes of URLs. For example, the discovery action system utilizes an iterative prompt generation process that incorporates previously generated discovery actions with a generative AI model to determine improved discovery actions for a specific URL class. These improved discovery actions are then used to determine new URLs for the class. Moreover, once the optimal URL discovery actions are determined for a URL class, the discovery action system facilitates the discovery of new URLs for the URL class without relying on the generative AI model.

Implementations of the present disclosure provide benefits and solve problems in the art with systems, computer-readable media, and computer-implemented methods that utilize the discovery action system to generate, determine, and execute URL discovery actions for URL classes. In particular, the discovery action system utilizes various models and processes to accurately create class-specific generative AI prompts for a generative AI model process and to determine the most effective discovery actions. Furthermore, once a set of discovery actions is determined for a URL class, the discovery action system efficiently carries out those actions without needing to utilize the generative AI model.

To illustrate how the discovery action system generates one or more sets of URL web crawling discovery actions using a generative AI model, in various implementations, the discovery action system identifies a URL class (e.g., a collection of related URLs) from a set of URL classes based on a discovery loss score associated with the URL class (the discovery loss score indicates the effectiveness of previously executed URL discovery actions for the URL class). The discovery action system also generates a URL discovery action prompt for the URL class. The URL discovery action prompt may include URL discovery instructions, class statistics, and previously executed URL discovery actions. Furthermore, the discovery action system receives a set of URL discovery actions for the URL class from a generative AI model in response to providing the URL discovery action prompt. The discovery action system also receives a report from a web crawler system based on the web crawler system executing an action from the set of URL discovery actions to discover a new set of URLs. Additionally, the discovery action system generates an updated actual discovery score and/or a discovery loss score for the URL class based on the set of discovered URLs indicated in the report.

As described in this disclosure, the discovery action system delivers several significant technical benefits in terms of improved accuracy and efficiency compared to existing web discovery computer systems. Moreover, the discovery action system provides several practical applications that address problems related to improving the accuracy and efficiency of using generative AI models, as well as using various models and processes to generate discovery actions for URL classes.

As mentioned above, when discovering new URLs, existing web discovery systems analyze outgoing URL links during an index recrawl cycle, with an emphasis on seed URLs to reveal additional new outgoing URL links with each visit. In some instances, some existing web discovery systems randomly sample from a list of millions or billions of URLs to crawl. These approaches are inefficient and waste computing resources. Furthermore, many sites limit the amount of traffic a crawler can generate, further hindering many existing web discovery systems.

In contrast to existing web discovery systems, implementations of the discovery action system efficiently solve the discovery problem. To elaborate, the discovery action system leverages contextual knowledge of URL classes, websites, and/or web domains to dynamically generate and execute targeted URL discovery actions. By utilizing a generative AI model based on a URL discovery action prompt that includes previously executed URL discovery actions for a URL class, the discovery action system determines accurate and refined URL discovery actions tailored for the URL class. Furthermore, once URL discovery actions are determined for a URL class, the discovery action system can quickly and efficiently execute them to discover new URLs.

Additionally, the discovery action system improves efficiency by minimizing the number of recrawls for a website or domain. Because the discovery action system determines improved URL discovery actions that are based on contextual knowledge of URL classes and previously executed URL discovery actions for the URL class, the discovery action system facilitates fewer crawls of these sites to discover new URLs. Fewer crawls result in fewer computational resources needed to discover new URLs and build search engine indexes. Fewer crawls also improve efficiency by better aligning with the limits sites have for web crawler traffic.

Additionally, the discovery action system improves accuracy by determining the best URL discovery actions for a URL class from multiple possible actions. For example, the generative AI model generates URL discovery actions for a class based on URL discovery actions previously executed for the class and their corresponding scores. Additionally, in various instances, the discovery action system utilizes both exploration and development sampling to select URL discovery actions to execute to identify the optimal actions for the class. In many instances, the discovery action system undergoes an iterative process to further improve the quality and effectiveness of URL discovery actions for a class. Furthermore, as described above, once optimal URL discovery actions are determined for a URL class, the discovery action system can quickly and efficiently execute them to discover new URLs.

As illustrated in the preceding discussion, this disclosure uses a variety of terms to describe the features and advantages of one or more described implementations. For example, this disclosure describes search engine indexing in the context of web discovery. As an example, the term “web discovery” refers to the process of finding and identifying new or updated web pages (e.g., URLs). Web discovery is commonly performed by web crawlers. As another example, the term “search engine indexing” refers to collecting, parsing, and storing data to facilitate fast and accurate information retrieval by creating a searchable database of web content.

As an example, the term “URL class” refers to a group, set, or collection of related URLs. For instance, a URL class refers to a common website, domain, host, or country shared by URLs within a URL class. When associated with a website, URLs in a URL class have or share the same or similar site crawling limits, site layouts, and site mappings. A URL class may be infinite in size, with URLs being added and removed from the class. In many instances, URL classes are exclusive. In some implementations, when URLs are associated with smaller websites, a URL class may include URLs that share a common query embedding, as described below.

As an example, the terms “URL discovery action,” “discovery action,” or simply “action” refer to a set of parameters that a system or tool, such as a web crawler, uses to identify new or updated URLs during a web crawl from a set of URLs. A URL discovery action provides instructions for selecting URLs to crawl from a set, determining when and how frequently to crawl, and specifying any constraints or conditions for the crawl. A URL discovery action may include a specific syntax for storing and executing actions. In some implementations, a URL action includes discovery conditions or constraints, an action time, a URL count, an action frequency, an expected discovery action score, an actual discovery action score, and/or a discovery loss score. A URL class may be associated with one or more URL discovery actions, which are generated specifically for the URL class. Additionally, the discovery action system may store URL discovery actions in a table or other datastore.

As an example, the term “generative artificial intelligence model” (or “generative AI model”) refers to an artificial intelligence computational system that utilizes deep learning and a large number of parameters (e.g., in the billions or trillions for a large version and fewer for a small version) that are trained on one or more extensive datasets to produce coherent, contextually relevant, and fluent topic-specific outputs (e.g., text and/or images). In many instances, a generative AI model refers to an advanced computational system that uses natural language processing, machine learning, and/or image processing to generate coherent and contextually relevant human-like responses.

Generative AI models have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats ranging from one-word answers to long narratives, images and videos, labeled datasets, documents, tables, and presentations.

Moreover, generative AI models are primarily based on transformer architectures to understand, generate, and manipulate human language. Generative AI models can also use other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models such as GPT-3.5 and GPT-4, bidirectional encoder representations from transformers (BERT) model, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), which serves as a text-based version of a generative AI model, such as one that receives text prompts and/or generates text outputs. In various implementations, a generative AI model is a multimodal generative model that receives multiple input formats (e.g., text, images, video, data structures) and/or generates multiple output formats.

As another example, the terms “prompt,” “model prompt,” or “generative AI model prompt” refer to a request provided to a large generative image model to create generative AI model output based on plain language guidance prompts. In various instances, the prompt is a URL class policy prompt that allows the generative AI model to produce one or more discovery actions with the smallest amount of discovery loss. In some instances, the discovery action system provides additional inputs or information (within the prompt or separately). In various implementations, prompts can include static data, URL class statistics, and dynamic data (e.g., previous URL discovery actions). An example of a prompt includes a URL discovery action prompt, as further described below.

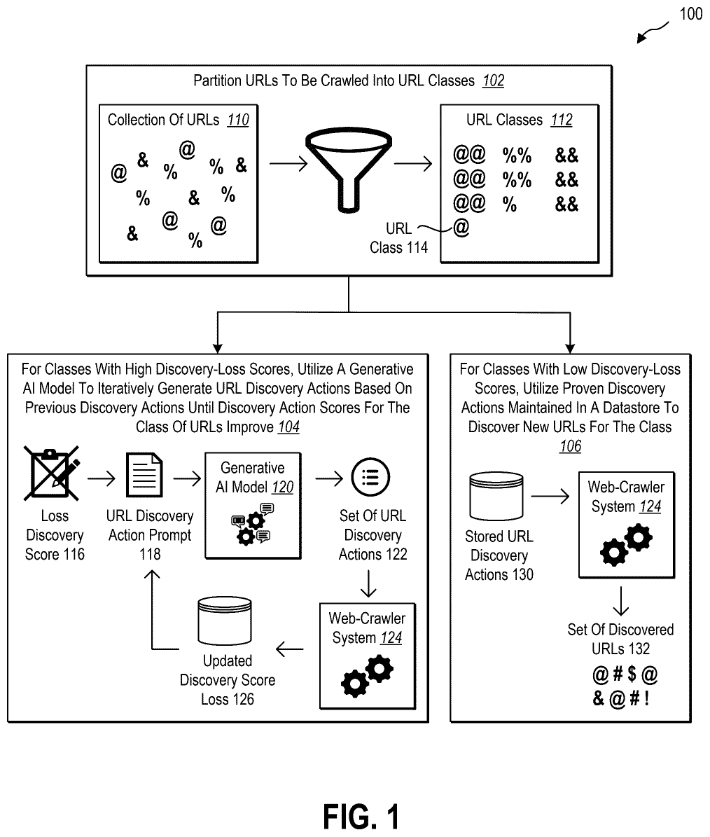

Implementation examples and details of the discovery action system are discussed in connection with the accompanying figures, which will be described next. For example, FIG. 1 illustrates an example of the discovery action system that utilizes prompt generation processes and generative artificial intelligence (AI) models to discover new uniform resource locators (URLs) according to some implementations. While FIG. 1 provides a high-level overview of the invention, additional details are provided in subsequent figures.

FIG. 1 illustrates a series of acts 100 performed by or following directions from the discovery action system. As shown, the series of acts 100 briefly illustrates an example of how the discovery action system utilizes prompt generation processes, models, and generative AI models to efficiently solve the URL discovery problem faced by existing web discovery systems.

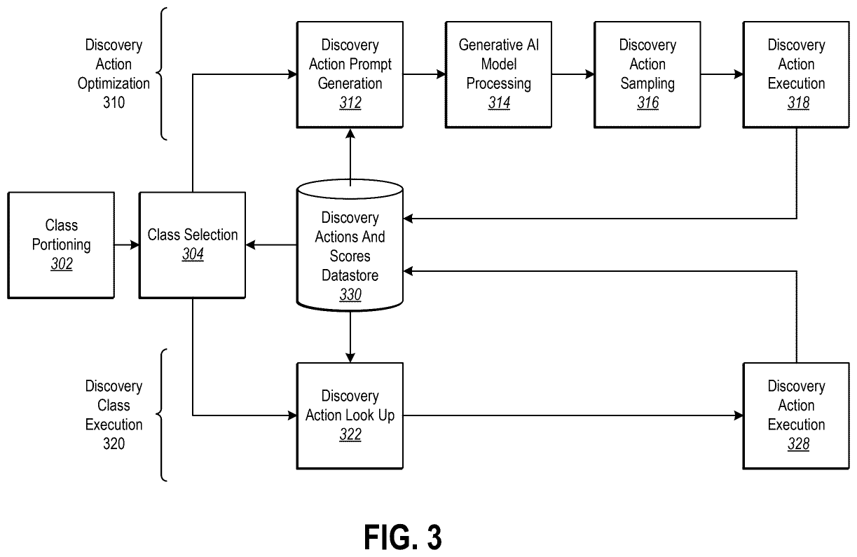

The series of acts 100 includes act 102 of partitioning URLs to be crawled into URL classes. For instance, the discovery action system partitions the space of all URLs (e.g., a collection of URLs 110) into different subspaces (e.g., URL classes 112) based on website, domain, country, host, or other factors. For example, the discovery action system divides some of the URLs from the collection of URLs 110 into a URL class 114 (e.g., the same URL class) based on the URLs belonging to the same website (or set of related websites), as further described below in connection with FIG. 3.

Based on the status of a URL class, the discovery action system may determine whether to further optimize URL discovery actions or execute URL discovery actions for the class. Furthermore, if the URL discovery actions are below a satisfactory threshold (measured based on discovery loss), the discovery action system proceeds to act 104. Otherwise, the discovery action system proceeds to act 106 to execute the URL discovery actions for URLs in the URL class.

As shown, act 104 is based on URL classes with unsatisfactory discovery loss scores, which indicate that better URL discovery actions for the URL classes are available. In particular, act 104 includes utilizing a generative AI model to iteratively generate URL discovery actions based on previous discovery actions until discovery action scores for the URL class improve. For example, the discovery action system performs the discovery action optimization process shown in connection with act 104 until discovery action scores for the selected URL class improve.

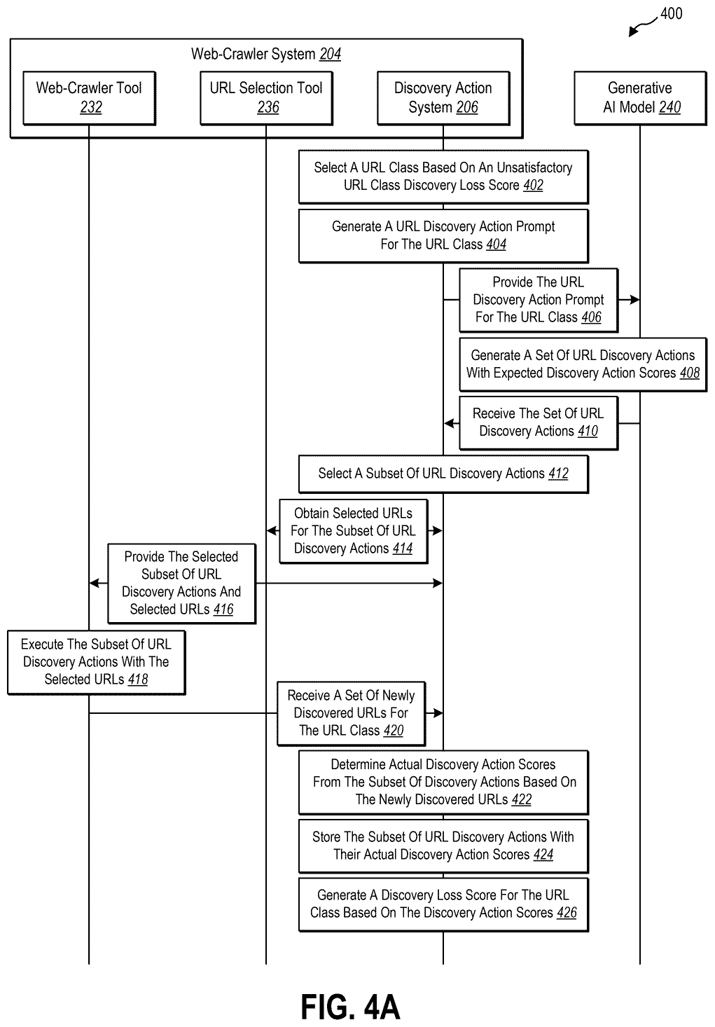

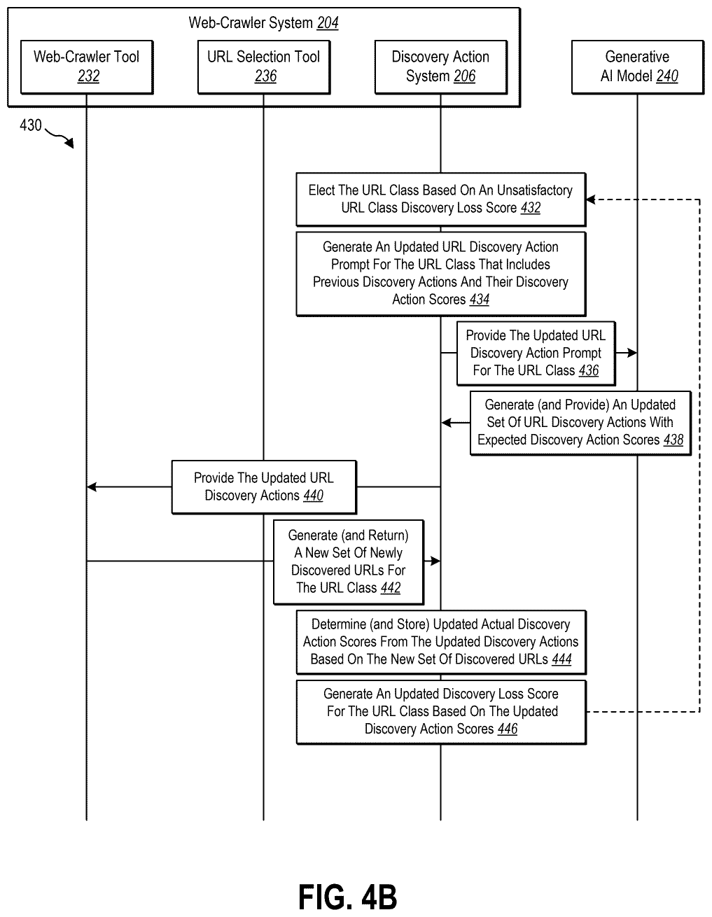

The discovery action optimization process in act 104 includes generating a URL discovery action prompt 118 based on a URL class having a loss discovery score 116 that is poor or unsatisfactory. Upon providing the URL discovery action prompt 118 to a generative AI model 120, the model returns a set of URL discovery actions 122. Additionally, the discovery action system provides the set of actions to a web crawler system 124 that discovers new URLs for the URL class, which the discovery action system uses to determine an updated loss discovery score 126. Details about generating URL discovery actions using a generative AI model and the discovery action optimization process are provided below in connection with FIG. 3 and FIG. 4A.

In addition, the discovery action optimization process associated with act 104 may iterate or repeat if the updated loss discovery score 126 is still unsatisfactory. For example, the discovery action system repeats act 104 to generate additional and/or different URL discovery actions for the URL class based, in part, on the previously generated URL discovery actions for the class. Based on executing some or all of the further generated URL discovery actions, the discovery action system again updates the loss discovery score. The process may repeat until the loss discovery score 116 for the URL class satisfies a loss discovery threshold or converges. Additional details about iterating the discovery action optimization process using the generative AI model are provided below in connection with FIG. 4B.

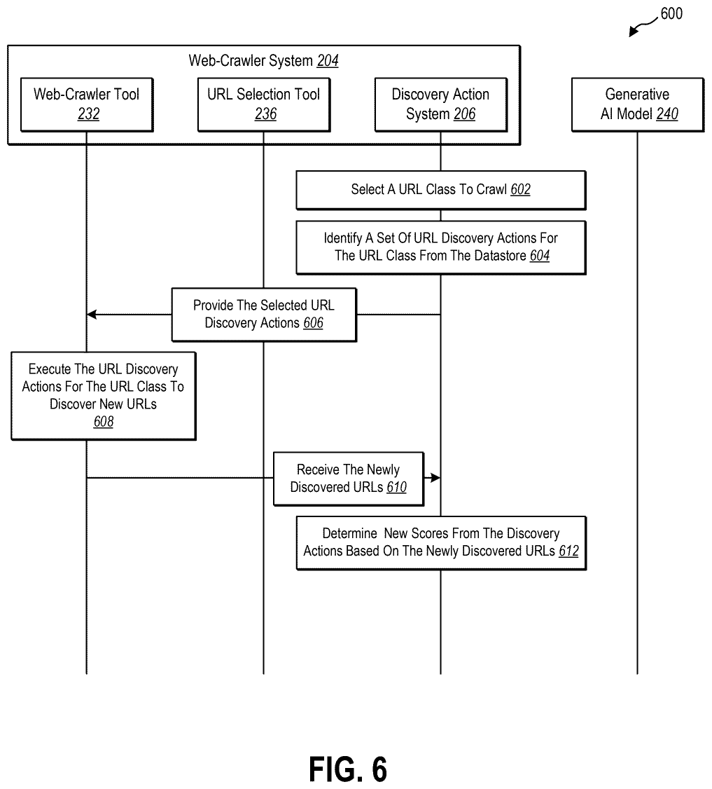

The discovery action system utilizes act 106 with the discovery loss score for a satisfactory URL class (e.g., a URL class with optimized discovery actions and low discovery loss scores). Act 106 shows a discovery action execution process and includes utilizing proven or optimized discovery actions maintained or stored in a datastore to discover new URLs for the URL class. For example, for a selected URL class, the discovery action system identifies stored URL discovery actions 130 from a datastore or database or URL discovery actions generated, evaluated, selected, and stored for the URL class. Using one or more of the stored URL discovery actions 130, the discovery action system uses the web crawler system 124 to generate a set of discovered URLs 132 for the URL class. More details about executing proven or optimized URL discovery actions and the discovery action execution process are provided below in connection with FIG. 3 and FIG. 6.

As shown by the arrow from act 106 to act 104, in various implementations, the discovery action system returns to act 104 to further refine and determine improved URL discovery actions for a URL class. For instance, the discovery action execution process of act 106 may continue to gather data while executing the URL discovery actions for the class, which the discovery action system uses to further improve the URL discovery action optimization process. Additionally, URL classes can change as URLs are added and removed from the class, the generative AI model 120 may be updated, and/or the discovery action system may utilize a different generative AI model in different iterations to improve URL discovery actions for a URL class.

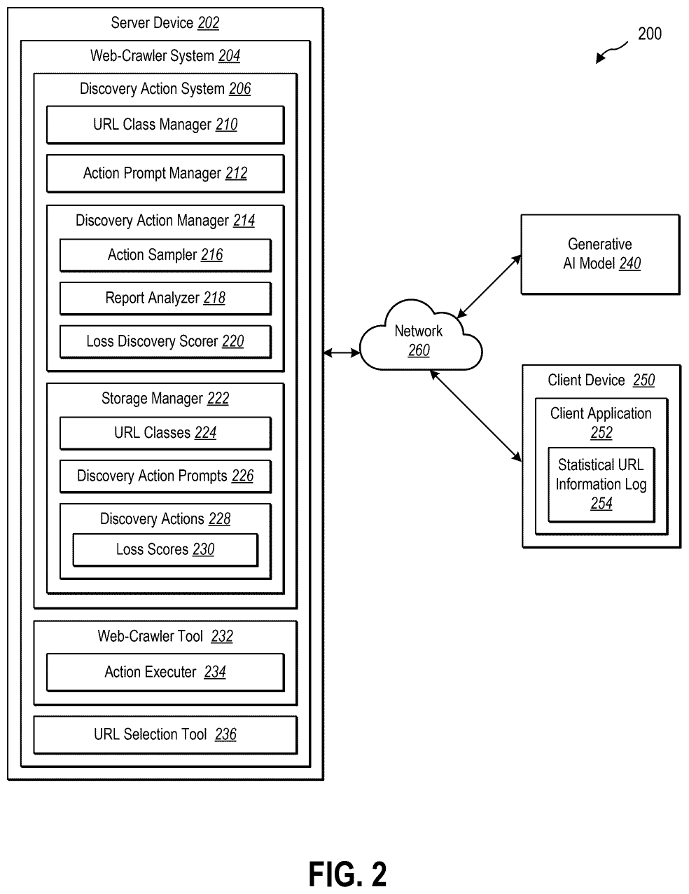

With a general overview in place, additional details are provided regarding the components, features, and elements of the discovery action system. To illustrate, FIG. 2 shows an example computing environment where the discovery action system is implemented according to some implementations. In particular, FIG. 2 illustrates an example of a computing environment 200 with various computing devices including a server device 202 associated with a discovery action system 206, a generative AI model 240, and a client device 250, connected via a network 260. While FIG. 2 shows example arrangements and configurations of the computing environment 200, the server device 202, the discovery action system 206, and associated components, other arrangements and configurations are possible.

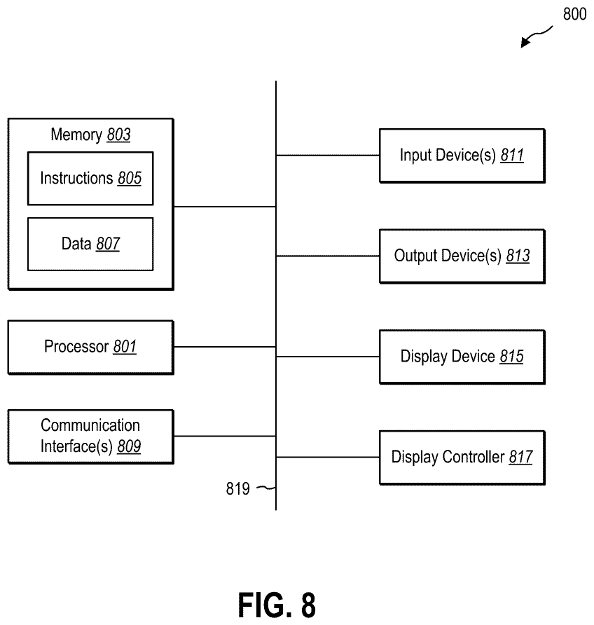

Many of these components shown may be implemented on one or more computing devices, such as on one or more server devices. In various implementations, some of these components (e.g., the generative AI model 240 and the client device 250) represent multiple component instances or component versions (e.g., the generative AI model 240 represents different versions of a generative model). In some instances, one or more components may be implemented on a personal device (e.g., the generative AI model is a small generative model located on a client device). Further details regarding computing devices are provided below in connection with FIG. 8, which also includes additional details regarding networks, such as the network 260 shown.

Before describing the components of the server device 202, including the discovery action system 206, other components of the computing environment 200 are discussed first to provide better context when describing the discovery action system 206. For example, the generative AI model 240, which may represent multiple generative models or multiple model instances, produces generative outputs (e.g., AI model outputs) based on prompt inputs (e.g., AI model prompts). For example, the generative AI model 240 generates a set of URL discovery actions when prompted with a URL discovery action prompt. Additionally, the generative AI model 240 can represent both large and small generative AI models.

As shown, the computing environment 200 includes the client device 250 with a client application 252. In various instances, the client device 250 includes a client application 252, such as a web browser, mobile application, or another type of computer application used to access and/or interact with the server device 202 and/or the web crawler system 204. In various implementations, the client device 250 is associated with a user (e.g., a user client device), such as a user who regularly engages in web browsing activity using the client application 252. In some cases, statistical URL data, such as visited URLs and timestamps (not tied to the user or associated with a random identifier), is stored in a log of statistical URL information 254 and later utilized by the discovery action system 206.

Returning to the server device 202, as shown, the server device 202 includes a web crawler system 204, a web crawler tool 232, and a URL selection tool 236. In various implementations, the web crawler system 204 facilitates the discovery of new URLs. For example, the web crawler system 204 directs URL searching, crawling, and storing URLs. In various implementations, the web crawler system 204 performs search engine indexing.

In various implementations, the web crawler system 204 implements the discovery action system 206. In some implementations, the discovery action system 206 is located on a separate computing device from the web crawler system 204 within the server device 202 (or apart from the server device 202). In various implementations, the web crawler system 204 operates without the discovery action system 206.

In various implementations, including the illustrated implementation, the discovery action system 206 includes various components and elements that are implemented in hardware and/or software. For example, the discovery action system 206 includes a URL class manager 210, an action prompt manager 212, a discovery action manager 214, and a storage manager 222. The discovery action manager 214 includes an action sampler 216, a report analyzer 218, and a loss discovery scorer 220. The storage manager 222 includes URL classes 224, discovery action prompts 226, and discovery actions 228 (with loss scores 230), among other data associated with the discovery action system 206.

In various implementations, the URL class manager 210 facilitates generating, modifying, updating, and removing URL classes 224 from a collection of identified URLs. In some instances, the URL class manager 210 determines if a URL class has an unsatisfactory discovery loss score and needs to have updated and/or discovery actions 228. In some implementations, the URL class manager 210 is located outside of the discovery action system 206.

In one or more implementations, the action prompt manager 212 facilitates generating and updating discovery action prompts 226 to provide to the generative AI model 240. For example, for URL classes 224 that need their discovery actions updated, the action prompt manager 212 generates one or more of the discovery action prompts based on the context of the URL class and previously executed discovery actions, and their loss scores. Furthermore, the action prompt manager 212 may provide the discovery action prompts 226 to the generative AI model 240 to generate discovery actions 228.

In various implementations, the discovery action manager 214 facilitates selecting, executing, analyzing, scoring, and/or otherwise managing discovery actions 228. For example, the discovery action manager 214 utilizes the action sampler 216 to sample or select a subset of the discovery actions 228 generated by the generative AI model 240 in response to a discovery action prompt. In some instances, the action sampler 216 provides the selected URL discovery actions to the web crawler tool 232 for execution.

In some implementations, the discovery action manager 214 utilizes the report analyzer 218 to obtain, analyze, and store the results of executed URL discovery actions. For example, the report analyzer 218 stores the discovery actions 228 and corresponding results within the storage manager 222 or another datastore. In various instances, the discovery action manager 214 utilizes the loss discovery scorer 220 to generate loss scores 230 for discovery actions 228 based on reported data, as further described below.

In various implementations, the web crawler tool 232 facilitates executing discovery actions 228. For example, the web crawler tool 232 utilizes an action executor 234 to run the provided URL discovery actions on a set of selected URLs for a URL class, as described below. In one or more implementations, the URL selection tool 236 determines which URLs from a URL are to be provided to the web crawler tool 232, as described below.

Turning to the next set of figures, these figures illustrate examples of the discovery action system 206 performing different processes to generate and execute improved URL discovery actions for URL classes. To begin, FIG. 3 provides a more detailed overview of the discovery action system 206. In particular, FIG. 3 illustrates an example flow diagram of the discovery action system performing discovery action optimization and discovery class execution according to some implementations.

As shown, FIG. 3 includes various actions (e.g., boxes) along with a datastore 330 (i.e., a datastore of discovery actions and scores). The actions start on the left and initially move to the right. The actions branch into a top path of discovery action optimization 310 or a bottom path of discovery class execution 320. Furthermore, both paths utilize and provide updated data to the datastore 330. In addition, as described below, both paths may be performed cyclically or iteratively.

To elaborate, as illustrated, the discovery action system 206 performs class portioning 302. For example, a web crawler system has a collection of URLs that includes a large number (e.g., millions or billions) of URLs to crawl or re-crawl for search engine indexing and other purposes. Furthermore, as the collection of URLs is crawled, new URLs appear and are added to the collection of URLs.

In various implementations, the discovery action system 206 partitions the collection of URLs into URL classes. URL classes can include a minimum number of URLs and no maximum limit. In some instances, the URL classes 112 are mutually exclusive (or mostly mutually exclusive).

In one or more implementations, the discovery action system 206 determines URL classes based on the website, domain, or country to which URLs belong. For example, instead of using a classifier, the discovery action system divides the collection of URLs 110 into URL classes 112 based on the websites to which they belong. In these cases, because URLs in a class are associated with the same website, the URL class shares common crawling limits, website layouts, and website mappings. This, in turn, allows the discovery action system 206 to determine tailored URL discovery actions based on both organizational and contextual information associated with the website.

In various implementations, the discovery action system 206 generates one or more URL classes based on contextual equivalence. The discovery action system 206 may perform a partitioning based on contextual equivalence for URLs that do not belong to a website-based URL class (e.g., there are too few URLs for a given website to form a URL class). For example, the discovery action system 206 utilizes an embedding neural network to determine latent embeddings of queries that would discover unclassified URLs. Then, the discovery action system 206 identifies clusters in the latent space and generates a URL class based on the URLs associated with a cluster.

FIG. 3 also shows that the discovery action system 206 performs class selection 304. For example, the discovery action system 206 analyzes the URL classes to identify which classes would benefit from URL discovery action optimization for crawling and re-crawling their URLs to discover new URLs. In some instances, the discovery action system 206 obtains metadata and other information about the URL class from the datastore 330 when determining whether to select a URL for optimization or execution.

In one or more implementations, the discovery action system 206 determines to select a URL class for optimization based on its discovery loss score (i.e., a discovery action loss score). As further described below, the discovery action system 206 generates one or more discovery loss scores for a URL based on the effectiveness of one or more discovery actions in the class, which may be determined by comparing an expected discovery action score with a corresponding actual discovery action score. For example, if the discovery loss score satisfies a discovery loss threshold (e.g., the loss score is equal to or greater than the loss threshold), then the discovery action system 206 selects the URL class for optimization.

The discovery loss threshold indicates when discovery actions in the URL class would benefit from optimization. In some implementations, a discovery loss score is a change in the loss amount between one or more current and previous URL discovery actions. In some instances, a discovery loss score is an accumulation and/or average of discovery loss across multiple discovery actions in a URL class. In various instances, the discovery loss score for a URL class is the highest or lowest discovery loss score for a single discovery action in the class. In one or more implementations, the discovery loss threshold is satisfied when the discovery loss score for a URL is above (or below) a discovery loss threshold limit or value (e.g., the URL class has a discovery loss score of X+1 amount and the discovery loss threshold is X).

If the discovery loss threshold is met, equaled, or satisfied for a URL class, the discovery action system may select a URL class for discovery action optimization 310. Otherwise, if the URL class includes proven or optimized URL discovery actions, then the discovery action system 206 selects the URL class for discovery class execution 320.

In various implementations, when selecting URL classes for discovery action optimization 310, the discovery action system 206 chooses or selects a URL with the highest, or a higher, discovery loss score. For example, the discovery action system 206 selects a URL class that has current URL discovery actions that perform more poorly in discovering new URLs compared to the discovery actions in other URL classes. As discussed below, a URL class may be repeatedly chosen or selected until its discovery loss score does not satisfy (e.g., does not exceed) the discovery loss threshold.

For a URL class selected for optimization, the discovery action system follows the top path of discovery action optimization 310. As shown, the discovery action optimization 310 includes discovery action prompt generation 312 for the URL class, which includes generating an AI model prompt customized to the URL class and includes previously executed discovery actions; generative AI model processing 314 of the AI model prompt to generate a set of URL discovery actions; discovery action sampling 316, which includes selecting a subset of discovery actions (and a sample of URLs from the class in some cases); and discovery action execution 318, which includes having a web crawler system execute the selected discovery actions. Additionally, the results of the discovery actions, including corresponding discovery loss scores, are stored in the datastore 330. Further details about the discovery action optimization process are provided below in connection with FIG. 4A.

As mentioned, the discovery action system 206 can repeat the discovery action optimization 310 for the same URL class until URL discovery actions are determined that produce lower (e.g., more favorable) loss scores. Additional details about iterating the discovery action optimization process to determine improved discovery loss scores are provided below in connection with FIG. 4B.

For a selected URL class, the discovery action system follows the bottom path of the discovery class execution 320. As shown, the discovery class execution 320 includes generating a discovery action look up 322, which includes identifying one or more discovery actions for the URL class from the datastore 330 (i.e., the discovery actions and scores datastore). These discovery actions have been proven and/or optimized for the URL class and saved in the datastore 330. Furthermore, the discovery class execution 320 includes discovery action execution 328 of the discovery actions for URLs in the URL class to identify new URLs. As shown, the results of the discovery actions, including corresponding discovery loss scores, may be stored in the datastore 330. Additional details about the discovery class execution 320 are provided below in connection with FIG. 6.

In some implementations, the discovery loss score of a URL class changes (e.g., increases or worsens) as a result of the discovery action system 206 performing the discovery class execution 320 for the URL class. For example, the discovery actions selected from the datastore 330 result in a less favorable discovery loss score. In these implementations, the discovery action system 206 may select the URL class for discovery action optimization 310 in the future.

In various implementations, the discovery action system 206 performs discovery action optimization 310 for a URL class even when it does not meet the discovery loss threshold. For example, if a URL class has not been optimized for a threshold amount of time or if the URL class has been executed in the discovery class execution 320 over a threshold number of times, the discovery action system 206 performs discovery action optimization 310 for the URL class. In this way, the discovery action system 206 ensures that URL classes stay as optimized as possible.

As mentioned above, FIGS. 4A-4B provide additional information regarding the optimization of the discovery action and the performance of multiple iterations of discovery action optimization. In particular, FIGS. 4A-4B illustrate example sequence diagrams for the discovery action system performing discovery action optimization to determine discovery actions using the generative AI model according to some implementations.

As shown, FIGS. 4A-4B show communication between the web crawler system 204 and the generative AI model 240. In particular, FIGS. 4A-4B show interactions between the web crawler tool 232, the URL selection tool 236, and the discovery action system 206 of the web crawler system 204. While FIGS. 4A-4B show communications, interactions, and acts in a particular order, the order and number of acts may differ.

FIG. 4A includes a series of acts 400 performed by or in connection with the discovery action system 206. As shown, the series of acts 400 includes act 402 of the discovery action system 206 selecting a URL class based on an unsatisfactory URL class discovery loss score. For example, the discovery action system 206 identifies the discovery loss scores of URL classes from a discovery action datastore to identify a URL class with a poor discovery loss score. The discovery loss score of the URL class may be poor compared to a discovery loss threshold or other URL classes.

Act 404 includes the discovery action system 206 generating a URL discovery action prompt for the URL class. For example, the discovery action system 206 analyzes the URL class and generates a URL discovery action prompt (“prompt” for short) for the URL class instructing the generative AI model 240 to determine a set of URL discovery actions. In various implementations, the prompt is a URL class policy prompt that causes the generative AI model 240 to produce one or more discovery actions with the minimum or smallest amount of loss. In one or more implementations, the discovery action system 206 includes a prompt with URL discovery instructions (e.g., a static portion), class statistics for the URL class, and/or previously executed URL discovery actions (e.g., a dynamic portion) for the URL class.

In some implementations, the URL discovery instructions direct the generative AI model to generate the set of URL discovery actions that follow an action syntax, which includes a discovery condition, an action time, a URL count, an action frequency, and an expected discovery action score. In many cases, the prompt instructs or directs the generative AI model 240 to generate a set of discovery actions tailored to the URL class using one or more inputs providing context information about the URL class. For example, the URL discovery instructions include directions to select discovery actions for crawling URLs from the URL class. In some instances, the instructions also include examples of discovery action syntax.

In many instances, a prompt also includes class statistics, which are a set of current statistics about the selected URL class. The class statistics can include the number of URLs in the class, the number of clicks, the number of clicks within one or more time periods (e.g., past 24 hours, week, year, or all time), and/or other statistics. In various implementations, the discovery action system 206 utilizes additional models to generate class statistics and/or metadata about the URL class for the generative AI model to process.

Because of input token limits, the prompt is unable to include all of the URLs. Accordingly, in various implementations, the class statistics include example URLs from the class. For example, the class statistics portion of the prompt includes examples of random URLs to give the generative AI model an idea of the type of URLs included in the URL class. In some instances, the class statistics include examples of good, positive, quality URLs (e.g., URLs within the class that included good seeds and/or performed exceptionally). In some instances, the class statistics also include examples of bad, negative, poor-quality URLs (e.g., poorly performing URLs).

In one or more implementations, the class statistics include structural data and context information about a website to which the URL is associated. For example, the class statistics include web crawler limits (e.g., a “politeness” measure), website layouts, and/or website mappings.

In various implementations, the prompt includes previously executed URL discovery actions for the URL class. For example, the discovery action system 206 provides a table of one or more previous URL discovery actions. In various implementations, a discovery action follows a given syntax, which may include time-of-day search times, URL analytics, URL content information, number of URLs, frequency of URLs, and scores (e.g., expected discovery action scores, actual discovery action scores, and/or discovery loss scores) for a URL discovery action.

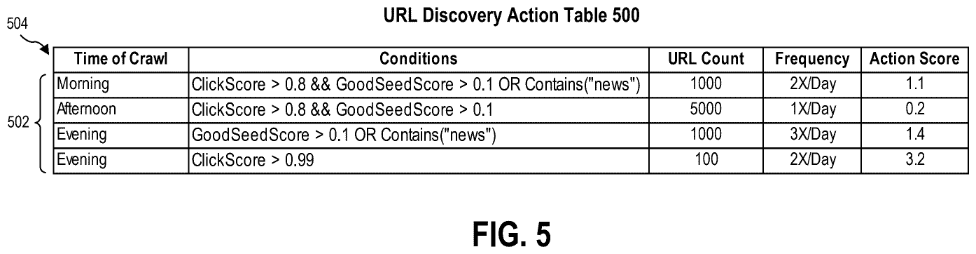

As mentioned, the previous URL discovery actions can include an expected discovery action score, an actual discovery action score, and/or a discovery loss score. For instance, a previously executed discovery action may include an actual discovery action score and/or a discovery loss score, while both executed and unexecuted discovery action may include an expected discovery action score. FIG. 5, which is described further below, includes an example of a discovery action table of previously generated discovery actions for a URL class.

Act 406 includes the discovery action system 206 providing the URL discovery action prompt for the URL class to the generative AI model 240. In various implementations, the discovery action system 206 provides previously generated discovery actions within the prompt. In some implementations, the previously generated discovery actions and/or class statistics are provided as separate inputs.

Act 408 includes the generative AI model 240 following the URL discovery action prompt to generate a set of URL discovery actions with expected discovery action scores. For example, the generative AI model 240 analyzes the context, statistics, structure, and limits of the URL class. In some implementations, the generative AI model uses internal learning (e.g., learned information about a website, domain, or country) to form a complete context of the URL class.

In addition, the generative AI model 240 may analyze the discovery actions previously provided or generated from the URL class to identify which discovery actions have been previously executed from the URL class. In particular, the generative AI model 240 may identify the scores associated with previous discovery actions to determine which discovery actions and portions of discovery actions are more effective. For example, a discovery action with a high expected discovery action score but a low actual discovery action score may indicate a poorly generated discovery action.

Additionally, after analyzing and identifying inputs included in the URL discovery action prompt, the generative AI model 240 generates a set of URL discovery actions tailored for the URL. In various implementations, the discovery actions provide the discovery action syntax defined in the prompt. Additionally, the generative AI model 240 may generate an expected discovery action score (e.g., expected reward) for each generated discovery action that corresponds to how successful the discovery action is anticipated to be at identifying new URLs when executed on URLs within the URL class. Examples of various discovery actions (following an example discovery action syntax) are shown in FIG. 5, which is described below.

Act 410 includes the discovery action system 206 receiving the set of URL discovery actions from the generative AI model 240. For example, the generative AI model 240 provides the set of URL discovery actions generated based on the latest data and inputs for the URL class in a text response, table, file, or other data structure.

In various implementations, the set of URL responses is ranked. For example, the discovery actions are ranked based on the expected discovery action scores. In some implementations, the number of discovery actions in the set is limited based on a threshold included in the prompt. In various implementations, the set of discovery actions includes only discovery actions having an expected discovery action score above an expected score threshold (e.g., an expected rewards threshold). In some implementations, the set of discovery actions includes a minimum number of URL discovery actions.

Act 412 includes the discovery action system 206 selecting a subset of URL discovery actions. For example, in various implementations, the discovery action system 206 selects one or more URL discovery actions provided by the generative AI model 240. In many implementations, the subset includes fewer than all of the provided discovery actions. However, in a few implementations, when the number of discovery actions in the subset is small, the subset includes all of the provided discovery actions.

In various implementations, the discovery action system 206 selects one, two, or more discovery actions based on their ranking. For example, the discovery action system 206 selects the top three ranked discovery actions for the subset. Additionally, in some implementations, the discovery action system 206 randomly selects one or more discovery actions from the set. Moreover, in some implementations, the discovery action system 206 selects one or more of the lower-ranked discovery actions. By doing so, the discovery action system 206 combines both exploitation (e.g., highest ranked) and exploration (e.g., lower ranked or random) approaches for the included discovery actions in the selected subset of URL discovery actions.

In various implementations, the discovery action system 206 stores selected and/or unselected URL discovery actions in a datastore, such as a database of discovery actions and scores. For example, the discovery action system 206 may record and track generated discovery actions for the URL class, even if they are not executed. This practice can reduce processing in future iterations of discovery action optimization for the URL class.

Act 414 includes the discovery action system 206 obtaining selected URLs for the subset of URL discovery actions from the URL selection tool 236. For example, in many instances, the number of URLs in the URL class is too large to execute with one or more selected discovery actions. Accordingly, the discovery action system 206 employs the URL selection tool 236 to select a number of URLs to be executed with the selected subset of discovery actions.

In various implementations, the URL selection tool 236 selects a number of URLs based on a URL count within one or more of the discovery actions. For instance, for each discovery action in the subset (or set), the URL selection tool 236 selects a corresponding number of URLs from the URL class. The URLs can overlap or be mutually exclusive. In some implementations, the discovery action system 206 identifies which discovery action includes the highest URL count and requests that number of URLs from the URL selection tool 236, which will cover all of the discovery actions.

Act 416 includes the discovery action system 206 providing the selected subset of URL discovery actions and selected URLs to the web crawler tool 232. In various implementations, the discovery action system 206 provides the subset of URL discovery actions and the selected URLs to the web crawler tool 232 for the web crawler tool 232 to execute the discovery actions on the URLs (e.g., the web crawler tool 232 determines which discovery actions to pair with which URLs). In some implementations, the discovery action system 206 indicates to the web crawler tool 232 which discovery actions are paired with which selected URLs.

Act 418 includes the web crawler tool 232 executing the subset of URL discovery actions with the selected URLs. In various implementations, the web crawler tool 232 utilizes the discovery action system to identify new URLs from the selected URLs. For example, for each discovery action, the web crawler tool 232 compares each selected URL to the discovery action to see if the discovery action returns a value of true or false. For URLs that return a true result, the web crawler tool 232 crawls them to discover new URLs. In some implementations, the web crawler tool 232 employs other techniques to discover new URLs from the selected URL using the discovery actions.

Act 420 includes the discovery action system 206 receiving a set of newly discovered URLs for the URL class from the web crawler tool 232. For example, the web crawler tool 232 provides a set of newly discovered URLs corresponding to each executed discovery action. The web crawler tool 232 may provide each discovery action/newly discovered URL set in a single message or a combined message.

In some implementations, the web crawler tool 232 provides a report to the discovery action system 206 indicating statistics and counts of the number of newly discovered URLs based on each discovery action or the discovery actions as a whole. In some implementations, the web crawler tool 232 provides the newly discovered URLs to the web crawler system 204 to be classified into URL classes, as described above.

Act 422 includes the discovery action system 206 determining actual discovery action scores from the subset of discovery actions based on the newly discovered URLs. For example, the discovery action system 206 compares the newly discovered URLs for a discovery action system to statistical URL information to determine an actual discovery action score for the discovery action.

As mentioned above, the discovery action system 206 may obtain statistical URL information that includes a list or log of URLs that have been visited by users and when these URLs were visited. In some instances, the discovery action system 206 partitions these logged URLs into the same URL classes and compares them to the newly discovered URLs. For example, the discovery action system 206 determines how many of the newly discovered URLs match URLs from the statistical URL information. Based on this comparison, the discovery action system 206 may determine the effectiveness of the discovery action.

To illustrate, in various implementations, the discovery action system 206 determines an actual discovery action score for the discovery action based on evaluating the number of found URLs, the number of clicks of all found URLs, the number of not found URLs, the number of crawls, and/or the number of crawls made. For example, the number of found URLs refers to how many newly discovered URLs match URLs from the statistical URL information. The number of missing or unfound URLs refers to how many URLs from the statistical URL information with the same URL class were not found among the newly discovered URLs.

In various implementations, the discovery action system 206 may limit measurements and comparisons to a given time period, such as the past week or month. In some implementations, the time period is from when a URL was discovered as indicated in the statistical URL information. Different variables may have different time periods.

In various implementations, the discovery action system 206 employs a formula to determine the actual discovery action score. For example, one such formula may be Actual_Discovery_Action_Score=NumberOfClicksOfAllFoundUrls−NumberOfNotFoundUrls−NumberOfCrawls−(NumberOfCrawlsMade/(NumberOfCrawlsMade+1)). As shown, the number of clicks for the found URLs positively contributes to the score while the number of not-found (e.g., missing or unfound) URLs and the number of crawls lower the score. In various instances, the NumberOfClicksOfAllFoundUrls variable is measured from URL discovery time in the statistical URL information to the present, and the NumberOfNotFoundUrls variable is measured from when a URL first appears in the statistical URL information. In some instances, one or more elements in the formula are weighted.

As described, the discovery action system 206 can compare newly discovered URLs with URLs previously visited in the statistical URL information to determine an actual discovery action score for a discovery action or URL class. In some implementations, the discovery action system 206 determines or updates the actual score after executing the discovery action. For example, at weekly intervals after executing a discovery action (for a period of time), the discovery action system 206 updates the actual score, which will change if the statistical URL information includes more found URLs and/or fewer missing (e.g., not found) URLs. These updated scores may then lead to updated discovery loss scores for the URL class.

Act 424 includes the discovery action system 206 storing the subset of URL discovery actions with their actual discovery action scores. For example, the discovery action system 206 adds the discovery actions, their expected discovery action scores, and their actual discovery action scores to the discovery actions and scores datastore. In some implementations, the discovery action system 206 adds the recently executed discovery actions to previously executed discovery actions in the datastore.

Act 426 includes the discovery action system 206 generating a discovery loss score for the URL class based on the discovery action scores. In various implementations, the discovery loss score is based on comparing the actual scores of discovery actions with their expected scores (e.g., the difference between the expected and measured effectiveness of a discovery action). As mentioned above, the discovery action system 206 may combine multiple discovery loss scores to determine a discovery loss score for the URL class. In some instances, the discovery action system 206 selects the loss score of one of the discovery actions to represent the loss score for the URL class, such as a discovery action with the highest, lowest, or median loss discovery action.

In some cases, while the discovery action optimization process determines discovery actions tailored for the URL class, the discovery actions still result in poor or unsatisfactory discovery loss scores (e.g., there is a large difference between the expected and actual scores). In these implementations, the discovery action system 206 iterates the discovery action optimization 310 to discover additional and/or different discovery actions that improve the discovery loss score of the URL class.

To illustrate, FIG. 4B shows the iteration of the discovery action optimization process using the generative AI model according to some embodiments. As shown, FIG. 4B includes another series of acts 430 to iterate the discovery action optimization process.

As shown, the series of acts 430 includes act 432 of the discovery action system 206 selecting the URL class based on an unsatisfactory URL class discovery loss score. For example, even if a URL has undergone the discovery action optimization process, if it has an unsatisfactory discovery loss score (e.g., it satisfies a discovery loss threshold indicating unoptimized discovery actions), the discovery action system 206 selects the URLs for another iteration of the discovery action optimization process.

Act 434 includes the discovery action system 206 generating an updated URL discovery action prompt for the URL class where the prompt includes previous discovery actions and their discovery action scores. In various implementations, the discovery action system 206 generates a URL discovery action prompt as described above. For example, the discovery action system 206 includes updated class statistics for the URL class.

Additionally, the discovery action system 206 includes the previously generated and/or executed URL discovery actions along with their expected and/or actual discovery action scores. In this way, the discovery action system 206 creates a reinforced, in-context learning environment where the generative AI model learns from the successes or failures of discovery actions that it previously generated. Indeed, the updated URL discovery action prompt allows the generative AI model to generate improved discovery actions for the URL class that leverage the information learned from previous discovery action optimization iterations for the URL class.

While this disclosure describes the discovery action system 206 generating an updated URL discovery action prompt, in various implementations, the discovery action system 206 generates a new URL discovery action prompt using updated URL class information, including updated class statistics and/or updated previous discovery actions and their corresponding scores.

Act 436 includes the discovery action system 206 providing the updated URL discovery action prompt for the URL class to the generative AI model 240. In response, the generative AI model 240 processes the updated prompt to generate new, additional, and/or different URL discovery actions for the URL class. As shown, act 438 includes the web crawler system 204 generating the updated URL discovery action prompt with expected discovery actions and providing the updated discovery actions to the 206/.

Act 440 includes the discovery action system 206 providing the updated URL discovery actions to the web crawler tool 232. In some implementations, the discovery action system 206 also obtains a selection of URLs from the URL selection tool 236, as described above, which are also provided to the web crawler tool 232.

Act 442 includes the web crawler tool 232 generating a new set of newly discovered URLs for the URL class. For example, the web crawler tool 232 executes the updated URL discovery actions with the selected URLs provided, as described above. The web crawler tool 232 then returns the new set of newly discovered URLs for the URL class to the discovery action system 206.

Act 444 includes the discovery action system 206 determining and storing updated actual discovery action scores from the updated discovery actions based on the new set of discovered URLs. The discovery action system 206 can generate and store actual discovery action scores for each of the updated discovery actions executed by the web crawler tool 232, as described above. Additionally, act 446 includes the discovery action system 206 generating an updated discovery loss score for the URL class based on the updated discovery action scores, which is also described above.

In various implementations, the discovery action system 206 continues to iterate 448 the discovery action optimization process until the discovery loss score for the URL class is optimized and no longer satisfies, equals, exceeds, or meets the discovery loss threshold. In some implementations, the discovery action system 206 iterates the discovery action optimization process until the expected and actual discovery action scores converge below the discovery loss threshold. Additionally, the discovery action system 206 may iterate the discovery action optimization process for a URL class if the time since the last optimization exceeds an optimization timing process (e.g., a day, a week, 15 days, a month, 6 months).

As mentioned above, FIG. 5 shows an example of a previous discovery action table for a URL class. As shown, a URL discovery actions table 500 includes URL discovery actions 502 for a URL class. In particular, the URL discovery actions 502 include actions that have been previously generated or generated and executed for the URL class. The URL discovery actions table 500 also includes components 504 of discovery actions. While one configuration of the table is shown, the table may include additional or different discovery action components

As shown, the URL discovery actions 502 include values for crawl time (e.g., time of day or time period for crawling), discovery action conditions, URL count, frequency, and action scores. In various implementations, the conditions column may indicate one or more conditional terms that a URL is required to meet before it is crawled to discover new URLs. For example, applying the condition to a selected URL results in a true or false condition result.

In some implementations, a conditional term is associated with a metric, such as a good seed score metric or a click score metric. In various implementations, one or more statistical models or other models generate these values for URLs so they can be compared with the conditional terms in a discovery action. In some instances, a conditional term is based on detecting a word or phrase within the URL (without having to access the content of the URL).

In various implementations, the URL count indicates the number of URLs on which to execute the discovery action in order to discover new URLs. In some instances, frequency indicates how often to perform the discovery action.

As shown, the URL discovery actions 502 include an action score in the URL discovery actions table 500. In various implementations, the action score includes an expected discovery action score. In some instances, the action score includes an actual discovery action score. In one or more implementations, the action score includes the discovery loss score for the discovery action.

As mentioned above, FIG. 6 provides additional details about executing proven or optimized URL discovery actions and the discovery action execution process. In particular, FIG. 6 illustrates an example sequence diagram of a discovery class execution process for discovering new URLs using proven or optimized discovery actions according to some implementations.

FIG. 6 also includes interactions between the web crawler tool 232, the URL selection tool 236, and the discovery action system 206 of the web crawler system 204. Notably, FIG. 6 does not include any interactions with the generative AI model 240. FIG. 6 also includes a series of acts 600 performed by or in connection with the discovery action system 206.

As shown, the series of acts 600 includes act 602 of the discovery action system 206 selecting a URL class to crawl. For example, the discovery action system 206 identifies a URL class that needs to be recrawled based on timing, the number of new URLs, or other factors. Upon checking the discovery loss score for the URL class, the discovery action system 206 determines that the URL class has an optimized set of discovery actions and is ready for discovery class execution (instead of discovery action optimization).

Act 604 includes the discovery action system 206 identifying a set of URL discovery actions for the URL class from the datastore. For example, the discovery action system 206 obtains some or all of the URL discovery actions in a database of discovery actions and scores for the URL class. In many implementations, the discovery actions in the datastore represent proven or optimized discovery actions for the URL class that yield expected rewards in terms of discovering new URLs during a crawl. In various implementations, the discovery action system 206 may select a subset of discovery actions, such as a random sample or a mix of random and highest-ranked actions, as described above.

Act 606 includes the discovery action system 206 providing the selected URL discovery actions to the web crawler tool 232 for execution. In some instances, as part of act 606, the discovery action system 206 obtains selected URLs from the URL class using the URL selection tool 236, as described above. In these implementations, the discovery action system 206 also provides the selected URLs to the web crawler tool 232 for execution with the provided discovery actions. As shown, act 608 includes the web crawler tool 232 executing the URL discovery actions for the URL class to discover new URLs, as described above.

Act 610 includes the discovery action system 206 receiving the newly discovered URLs from the web crawler tool 232. For example, the web crawler tool 232 provides the results of the discovery action execution to the discovery action system 206. In some implementations, the web crawler tool 232 provides the newly discovered URLs to another system or tool of the web crawler system 204 for search engine indexing.

Act 612 includes the discovery action system 206 determining new scores from the discovery actions based on the newly discovered URLs. For example, in some implementations, the discovery action system 206 updates the actual discovery action score or the discovery loss score for the discovery action based on the newly discovered URLs. In various implementations, the discovery action system 206 also updates the discovery loss score for the URL class based on the updated discovery action scores. In this way, the discovery action system 206 continues to efficiently monitor the current effectiveness of the discovery actions of a URL class.

As mentioned above, in various implementations, the discovery action system 206 determines to iterate or rerun a URL class through the discovery action optimization process at given time intervals. This ensures that the discovery actions of the URLs are as optimal as possible given any recent changes occurring in the URL class.

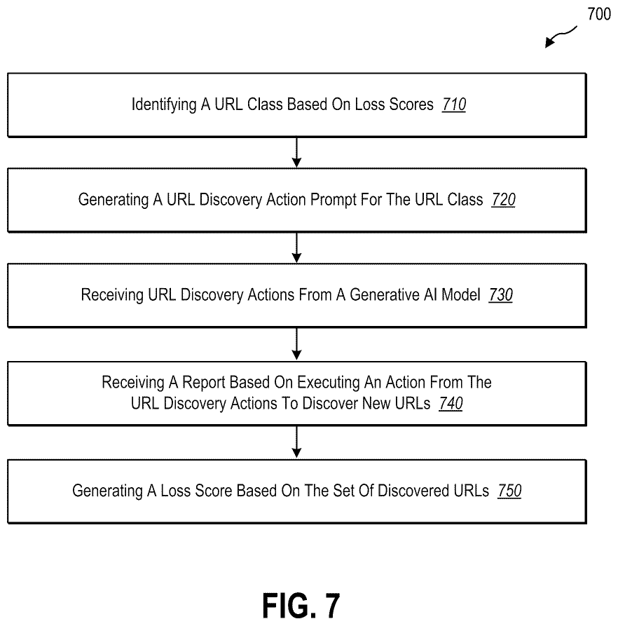

Turning now to FIG. 7, this figure illustrates an example series of acts of a computer-implemented method for generating one or more sets of uniform resource locator (URL) web crawling discovery actions using one or more generative artificial intelligence (AI) models according to some implementations. While FIG. 7 illustrates acts according to one or more implementations, alternative implementations may omit, add to, reorder, and/or modify any of the acts shown.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions or steps.

As shown, the series of acts 700 includes act 710 of identifying a URL class based on loss scores. For instance, in example implementations, act 710 involves identifying an identified URL class from a set of URL classes based on a discovery loss score associated with the identified URL class, where the identified URL class includes a collection of URLs and where the discovery loss score indicates the effectiveness of previously executed URL discovery actions for the identified URL class. In some implementations, act 710 includes identifying a corpus of URLs and partitioning the collection of URLs from the corpus of URLs into the identified URL class based on URLs in the collection of URLs sharing a common website domain.

As further shown, the series of acts 700 includes act 720 of generating a URL discovery action prompt for the URL class. For instance, in example implementations, act 720 involves generating a URL discovery action prompt for the identified URL class, where the prompt includes URL discovery instructions, class statistics for the identified URL class, and a table of previously executed URL discovery actions for the identified URL class.

In some implementations, act 720 includes identifying the identified URL class from the set of URL classes by determining or identifying the discovery loss score of the identified URL class and the discovery loss scores of additional URL classes in a URL discovery action datastore, comparing the discovery loss score of the identified URL class with the discovery loss scores of the additional URL classes to determine that the discovery loss score of the identified URL class is equal to or greater than the discovery loss scores of the additional URL classes, and selecting the identified URL class based on the discovery loss score of the identified URL class. In some implementations, the URL discovery instructions direct the generative AI model to generate the set of URL discovery actions that follow an action syntax that includes a discovery condition, an action time, a URL count, an action frequency, and an expected discovery action score.

In some implementations, the class statistics for the identified URL class include the number of URLs in the identified URL class, the number of clicks, and URL examples. In some implementations, the URL examples include positive URL examples and random URL examples of the identified URL class. In some implementations, the previously executed URL discovery actions for the identified URL class include previous URL discovery actions executed by the web crawler system based on previous sets of URL discovery actions provided by the generative AI model for the identified URL class and actual discovery action scores corresponding to the previous URL discovery actions determined based on the results of the previous URL discovery actions being executed. In various implementations, the previously executed URL discovery actions for the identified URL class include the discovery loss score for the identified URL class determined based on the actual discovery action scores of the previous URL discovery actions.

As further shown, the series of acts 700 includes act 730 of receiving URL discovery actions from a generative AI model. For instance, in example implementations, act 730 involves receiving a set of URL discovery actions for the identified URL class from a generative AI model in response to providing the URL discovery action prompt for the identified URL class to the generative AI model. In various implementations, act 730 includes providing the URL discovery action prompt to the generative AI model for the identified URL class and receiving a URL discovery action response that includes the set of URL discovery actions for the identified URL class. In some implementations, act 730 includes providing the URL discovery action prompt to the generative AI model for the identified URL class and receiving a URL discovery action response that includes the set of URL discovery actions for the identified URL class.

As shown further, the series of acts 700 includes act 740 of receiving a report based on executing an action from the URL discovery actions to discover new URLs. For instance, in example implementations, act 740 involves receiving a report from a web crawler system based on the web crawler system executing an action from the set of URL discovery actions for the identified URL class to discover a set of discovered URLs.

In some implementations, act 740 includes determining that the number of URL discovery actions in the set of URL discovery actions exceeds a URL discovery action threshold, selecting a subset of URL discovery actions for the identified URL class from the set of URL discovery actions for the identified URL class based on the URL discovery action threshold being exceeded, providing the subset of URL discovery actions for the identified URL class to the web crawler system, and receiving the set of discovered URLs discovered by the web crawler system executing the subset of URL discovery actions. In some implementations, act 740 includes determining that the number of URLs in the collection of URLs for the identified URL class exceeds a URL count included in the action, selecting a random subset of URLs for the identified URL class from the collection of URLs for the identified URL class based on the URL count for the action being exceeded, and providing the action and the random subset of URLs to the web crawler system for discovering new URLs within the random subset of URLs by following the action.

As further shown, the series of acts 700 includes act 750 of generating a loss score based on the set of discovered URLs. In some instances, in example implementations, act 750 involves generating an updated discovery loss score for the identified URL class based on the set of discovered URLs indicated in the report. In some instances, in example implementations, act 750 involves generating an actual discovery score for the action based on the set of discovered URLs indicated in the report.

In some implementations, act 750 includes receiving the report from the web crawler system that includes a set of newly discovered URLs identified from executing the action, identifying a set of previously identified URLs for the identified URL class from a statistical URL information log, and determining an actual discovery action score for the action based on the report and the set of previously identified URLs for the identified URL class. In some instances, determining the actual discovery action score for the action includes determining the total number of clicks for the set of newly discovered URLs based on click counts included in the set of previously identified URLs for the identified URL class, determining the number of unfound URLs based on comparing the set of newly discovered URLs to the set of previously identified URLs for the identified URL class, and generating the actual discovery action score for the action based on the total number of clicks for the set of newly discovered URLs, the number of unfound URLs, and the number of crawls of the action.

In various implementations, act 750 includes storing the action and the actual discovery action score in a URL discovery action datastore. In some implementations, act 750 includes generating an updated loss score for the identified URL class based on comparing an expected discovery action score for the action and the actual discovery action score for the action, and storing the updated loss score for the identified URL class within the URL discovery action datastore.

In some implementations, the series of acts 700 includes one or more additional acts. For example, the series of acts 700 includes identifying the identified URL class from the set of URL classes based on the updated discovery loss score of the identified URL class; generating an additional URL discovery action prompt for the identified URL class where the prompt includes the URL discovery instructions, updated class statistics for the identified URL class, and the table of the previously executed URL discovery actions for the identified URL class, where the previously executed URL discovery actions include the action and an actual discovery score corresponding to previously executing the action; and providing the additional URL discovery action prompt to the generative AI model to generate an updated set of URL discovery actions for the identified URL class.

In some instances, the series of acts 700 includes determining that the identified URL class has converged based on the updated discovery loss score being within a convergence threshold of the discovery loss score; updating the identified URL class with an updated collection of URLs that differs from the collection of URLs; identifying an additional action for the identified URL class stored in a URL discovery action datastore without providing a URL discovery action prompt to the generative AI model; and providing the additional action to the web crawler system for discovering an additional set of discovered URLs.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, and a data bus. For clarity, the various buses are illustrated in FIG. 8 as a bus system 819.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Instead, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to exclude the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

1. A computer-implemented method for generating one or more sets of uniform resource locator (URL) web crawling discovery actions using one or more generative artificial intelligence (AI) models, comprising:
identifying an identified URL class from a set of URL classes based the identified URL class having discovery loss score that satisfies a discovery loss score threshold, wherein the identified URL class includes a collection of URLs, wherein the discovery loss score indicates a difference in discovery action scores of previously executed URL discovery actions for the identified URL class, and wherein the discovery loss score threshold indicates an unoptimized URL discovery action set for a URL class;
generating a URL discovery action prompt for the identified URL class, the URL discovery action prompt including URL discovery instructions, class statistics for the identified URL class, and the previously executed URL discovery actions for the identified URL class;
receiving a set of URL discovery actions for the identified URL class from a generative AI model in response to providing the URL discovery action prompt for the identified URL class to the generative AI model;
receiving a URL discovery report from a web crawler system, wherein the URL discovery report includes a set of discovered URLs for the identified URL class, and wherein the set of discovered URLs are discovered based on the web crawler system executing an action from the set of URL discovery actions for the identified URL class; and
generating an updated discovery loss score for the identified URL class based on the set of discovered URLs indicated in the URL discovery report and the set of URL discovery actions received from the generative AI model, wherein the updated discovery loss score no longer satisfies the discovery loss score threshold, and wherein the updated discovery loss score indicates that the set of URL discovery actions for the identified URL class cause the web crawler system to perform fewer re-crawls than the previously executed URL discovery actions for the identified URL class.

2. The computer-implemented method of claim 1, wherein the URL discovery instructions direct the generative AI model to generate the set of URL discovery actions that follow an action syntax that includes a discovery condition, an action time, a URL count, an action frequency, and an expected discovery action score.

3. The computer-implemented method of claim 2, wherein the class statistics for the identified URL class include a number of URLs in the identified URL class, a number of clicks, and URL examples.

4. The computer-implemented method of claim 3, wherein the URL examples include positive URL examples and random URL examples of the identified URL class.

5. The computer-implemented method of claim 2, wherein the previously executed URL discovery actions for the identified URL class include:
previous URL discovery actions executed by the web crawler system based on previous sets of URL discovery actions provided by the generative AI model for the identified URL class; and
actual discovery action scores corresponding to the previous URL discovery actions determined based on results of the previous URL discovery actions being executed.

6. The computer-implemented method of claim 5, wherein the previously executed URL discovery actions for the identified URL class include the discovery loss score for the identified URL class determined based on the actual discovery action scores of the previous URL discovery actions.

7. The computer-implemented method of claim 1, further comprising:
determining that a number of URL discovery actions in the set of URL discovery actions exceeds a URL discovery action threshold;
selecting a subset of URL discovery actions for the identified URL class from the set of URL discovery actions for the identified URL class based on the URL discovery action threshold being exceeded;
providing the subset of URL discovery actions for the identified URL class to the web crawler system; and
receiving the set of discovered URLs discovered by the web crawler system executing the subset of URL discovery actions.

8. The computer-implemented method of claim 7, further comprising:
determining that a number of URLs in the collection of URLs for the identified URL class exceeds a URL count included in the action;
selecting a random subset of URLs for the identified URL class from the collection of URLs for the identified URL class based on the URL count for the action being exceeded; and
providing the action and the random subset of URLs to the web crawler system for discovering new URLs within the random subset of URLs by following the action.

9. The computer-implemented method of claim 1, further comprising:
receiving the URL discovery report from the web crawler system that includes a set of newly discovered URLs identified from executing the action;
identifying a set of previously identified URLs for the identified URL class from a statistical URL information log; and
determining an actual discovery action score for the action based on the URL discovery report and the set of previously identified URLs for the identified URL class.

10. The computer-implemented method of claim 9, wherein determining the actual discovery action score for the action includes:
determining a number of clicks for the set of newly discovered URLs based on click counts included in the set of previously identified URLs for the identified URL class;
determining a number of unfound URLs based on comparing the set of newly discovered URLs to the set of previously identified URLs for the identified URL class; and
generating the actual discovery action score for the action based on the number of clicks for the set of newly discovered URLs, the number of unfound URLs, and a number of crawls of the action.

11. The computer-implemented method of claim 10, further comprising storing the action and the actual discovery action score in a URL discovery action datastore.

12. The computer-implemented method of claim 11, further comprising:
generating an updated loss score for the identified URL class based on comparing an expected discovery action score for the action and the actual discovery action score for the action; and
storing the updated loss score for the identified URL class within the URL discovery action datastore.

13. The computer-implemented method of claim 1, further comprising:
re-identifying, after generating an initial updated discovery loss score for the identified URL class, the identified URL class from the set of URL classes based on the initial updated discovery loss score of the identified URL class satisfying the discovery loss score threshold;
generating an additional URL discovery action prompt for the identified URL class, the additional URL discovery action prompt including the URL discovery instructions, class statistics for the identified URL class updated based on the set of URL discovery actions, and the previously executed URL discovery actions for the identified URL class, wherein the previously executed URL discovery actions include the action and an actual discovery score corresponding to previously executing the action; and
providing the additional URL discovery action prompt to the generative AI model to generate an updated set of URL discovery actions for the identified URL class.

14. The computer-implemented method of claim 1, further comprising:
determining that the identified URL class has converged based on the updated discovery loss score being within a convergence threshold of the discovery loss score;
updating the identified URL class with an updated collection of URLs that differs from the collection of URLs;
identifying an additional action for the identified URL class stored in a URL discovery action datastore without providing a URL discovery action prompt to the generative AI model; and
providing the additional action to the web crawler system for discovering an additional set of discovered URLs.

15. A computer-implemented method for generating one or more sets of uniform resource locator (URL) web crawling discovery actions using one or more generative artificial intelligence (AI) models, comprising:
identifying an identified URL class from a set of URL classes based the identified URL class having discovery loss score that satisfies a discovery loss score threshold, wherein the identified URL class includes a collection of URLs, wherein the discovery loss score indicates a difference in discovery action scores of previously executed URL discovery actions for the identified URL class, and wherein the discovery loss score threshold indicates an unoptimized URL discovery action set for a URL class;
generating a URL discovery action prompt for the identified URL class, the URL discovery action prompt including URL discovery instructions, class statistics for the identified URL class, and the previously executed URL discovery actions for the identified URL class;
receiving a set of URL discovery actions for the identified URL class from a generative AI model in response to providing the URL discovery action prompt for the identified URL class to the generative AI model;
receiving a URL discovery report from a web crawler system, wherein the URL discovery report includes a set of discovered URLs for the identified URL class, and wherein the set of discovered URLs are discovered based on the web crawler system executing an action from the set of URL discovery actions for the identified URL class; and
generating an updated discovery loss score for the identified URL class based on the set of discovered URLs indicated in the URL discovery report and the set of URL discovery actions received from the generative AI model, wherein the updated discovery loss score no longer satisfies the discovery loss score threshold, and wherein the updated discovery loss score indicates that the set of URL discovery actions for the identified URL class cause the web crawler system to perform fewer re-crawls than the previously executed URL discovery actions for the identified URL class.

16. The computer-implemented method of claim 15, further comprising partitioning the collection of URLs into the identified URL class based on URLs in the collection of URLs sharing a common website, domain, or country.

17. The computer-implemented method of claim 15, wherein identifying the identified URL class from the set of URL classes includes:
identifying the discovery loss score of the identified URL class and discovery loss scores of additional URL classes in a URL discovery action datastore;
comparing the discovery loss score of the identified URL class with the discovery loss scores of the additional URL classes to determine that the discovery loss score of the identified URL class is equal to or greater than the discovery loss scores of the additional URL classes; and
selecting the identified URL class based on the discovery loss score of the identified URL class.

18. The computer-implemented method of claim 15, further comprising:
providing the URL discovery action prompt to the generative AI model for the identified URL class; and
receiving a URL discovery action response that includes the set of URL discovery actions for the identified URL class.

19. A system comprising:
a processing system; and
a computer memory comprising instructions that, when executed by the processing system, cause the system to perform operations of:
identifying an identified URL class from a set of URL classes based the identified URL class having discovery loss score that satisfies a discovery loss score threshold, wherein the identified URL class includes a collection of URLs, wherein the discovery loss score indicates a difference in discovery action scores of previously executed URL discovery actions for the identified URL class, and wherein the discovery loss score threshold indicates an unoptimized URL discovery action set for a URL class;
generating a URL discovery action prompt for the identified URL class, the URL discovery action prompt including URL discovery instructions, class statistics for the identified URL class, and the previously executed URL discovery actions for the identified URL class;
receiving a set of URL discovery actions for the identified URL class from a generative AI model in response to providing the URL discovery action prompt for the identified URL class to the generative AI model;
receiving a URL discovery report from a web crawler system, wherein the URL discovery report includes a set of discovered URLs for the identified URL class, and wherein the set of discovered URLs are discovered based on the web crawler system executing an action from the set of URL discovery actions for the identified URL class; and
generating an updated discovery loss score for the identified URL class based on the set of discovered URLs indicated in the URL discovery report and the set of URL discovery actions received from the generative AI model, wherein the updated discovery loss score no longer satisfies the discovery loss score threshold, and wherein the updated discovery loss score indicates that the set of URL discovery actions for the identified URL class cause the web crawler system to perform fewer re-crawls than the previously executed URL discovery actions for the identified URL class.

20. The system of claim 19, wherein:
the URL discovery instructions direct the generative AI model to generate the set of URL discovery actions that follow an action syntax that includes a discovery action, an action time, a URL count, an action frequency, and an expected discovery action score;
the class statistics for the identified URL class include a number of URLs in the identified URL class, a number of clicks, and URL examples; and
the previously executed URL discovery actions for the identified URL class include:
previous URL discovery actions executed by the web crawler system based on previous sets of URL discovery actions provided by the generative AI model for the identified URL class; and
actual discovery action scores corresponding to the previous URL discovery actions are determined based on results of the previous URL discovery actions being executed.
